(19) United States
(12) Patent Application Publication
(10) Pub. No.: US 2012/0195373 A1
(43) Pub. Date: Aug. 2, 2012

(54) INVERSE DISCRETE COSINE TRANSFORMING APPRATUS, DECODER, AND IMAGE PROCESSING APPARATUS

(75) Inventor: Milosz Gabriel Sroka Chalot, Yokohama-Shi (JP)

(73) Assignee: KABUSHIKI KAISHA TOSHIBA, Tokyo (JP)

(21) Appl. No.: 13/069,572

(22) Filed: Mar. 23, 2011

(30) Foreign Application Priority Data
Jan. 27, 2011 (JP) 2010-015373

(51) Int. Cl. H04N 7/26; G06K 9/46

(52) U.S. Cl. 375/240.03; 382/250; 375/E07.125; 375/E07.226

(57) ABSTRACT

According to one embodiment, an inverse discrete cosine transforming apparatus includes an inverse scan module, an inverse quantization module, a coefficient selector and an inverse discrete cosine transform module. The inverse scan module arrays a plurality of coefficients constituting decoded variable length data generated from bit stream of coded data in a predetermined scan order to generate inverse scan data. An inverse quantization module performs an inverse quantization on the inverse scan data to generate a discrete cosine transform coefficient. The coefficient selector generates an extending signal for each scan data. The inverse discrete cosine transform module performs an inverse discrete cosine transform on the discrete cosine transform coefficient based on the extending signal to generate decoded image data.

### CROSS REFERENCE TO RELATED APPLICATIONS

This application is based upon and claims the benefit of priority from the prior Japanese Patent Application No. 20 2011-15373, filed on Jan. 27, 2011, the entire contents of which are incorporated herein by reference.

### FIELD

Embodiments described herein relate generally to an inverse discrete cosine transforming apparatus, a decoder, and an image processing apparatus.

### BACKGROUND

A conventional decoder generates a DCT (Discrete Cosine Transform) coefficient by performing inverse quantization on bit stream of coded image data, generates a decoded pixel value by performing an IDCT (Inverse Discrete Cosine Transform) on the DCT coefficient, and generates a decoded pixel by adding the decoded pixel value and a predicted pixel value. The IDCT is evenly performed on all the bit streams irrespective of an encode type.

Generally, a decoder is set to a decoding mode that reduces a processing amount in order to improve a processing rate and power consumption. However, when the conventional decoder is set to the decoding mode, image quality is degraded while the processing amount is reduced.

### BRIEF DESCRIPTION OF THE DRAWINGS

FIG. 1 is a block diagram illustrating a configuration of an image processing apparatus 1 of the embodiment.

FIG. 2 is a block diagram illustrating a configuration of the decoder 10.

FIG. 3 is a schematic diagram illustrating a data structure of the decoded variable length data DVLC.

FIG. 4 is a block diagram illustrating a configuration of the IDCT part 12.

FIG. 5 is a flowchart illustrating a procedure of the IDCT.

FIG. 6A is a schematic diagram illustrating a zigzag scan mode.

FIG. 6B is a schematic diagram illustrating an alternate scan mode.

FIGS. 7A to 7C are schematic diagrams respectively illustrating an example of the inverse scan (S501).

FIGS. 8A to 8F are schematic diagrams respectively illustrating a decoding mode.

FIG. 9 is a flowchart illustrating a procedure of the coefficient selection (S503).

FIG. 10 is a flowchart illustrating a procedure of the IDCT (S504) for “DM=1”.

FIGS. 11A to 11F are schematic diagrams respectively illustrating a DCT coefficient obtained in IDCT (S504).

FIG. 12 is a flowchart illustrating a procedure of the IDCT (S504) for “DM=2”.

FIG. 13 is a flowchart illustrating a procedure of the IDCT (S504) for “DM=3”.

FIG. 14 is a block diagram illustrating a configuration of the motion vector part 13.

FIG. 15 is a schematic diagram illustrating a logic circuit implementing the coefficient selector 123.

### DETAILED DESCRIPTION

Embodiments will now be explained with reference to the accompanying drawings.

In general, according to one embodiment, an inverse discrete cosine transforming apparatus includes an inverse scan module, an inverse quantization module, a coefficient selector and an inverse discrete cosine transform module. The inverse scan module arrays a plurality of coefficients constituting decoded variable length data generated from bit stream of coded data in a predetermined scan order to generate inverse scan data. An inverse quantization module performs an inverse quantization on the inverse scan data to generate a discrete cosine transform coefficient. The coefficient selector generates an extending signal for each scan data. The inverse discrete cosine transform module performs an inverse discrete cosine transform on the discrete cosine transform coefficient based on the extending signal to generate decoded image data.

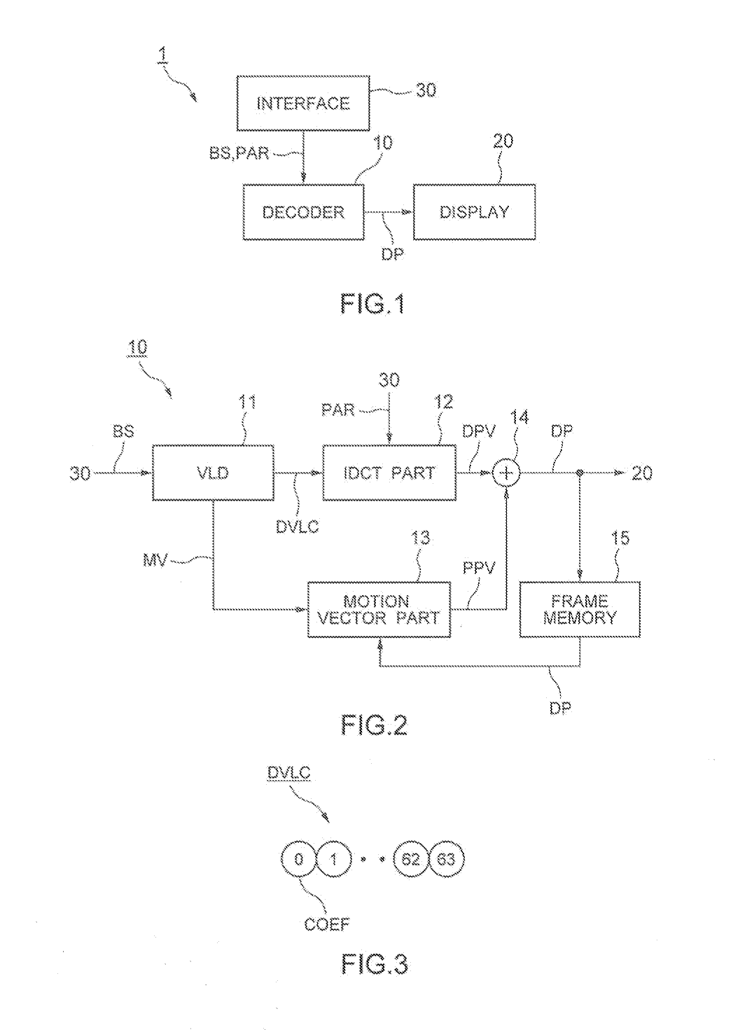

Hereafter, an image processing apparatus of the embodiment will be explained more specifically. FIG. 1 is a block diagram illustrating a configuration of an image processing apparatus 1 of the embodiment. The image processing apparatus 1 includes a decoder 10, a display 20, and an interface 30. For example, the image processing apparatus 1 is incorporated in a mobile device such as a mobile phone.

The decoder 10 performs decoding to decode the coded data. The decoder 10 generates a decoded pixel DP from bit stream BS of the coded data and a parameter PAR from the interface 30.

The display 20 displays an image based on the decoded pixel DP from the decoder 10. For example, the display 20 is a LCD (Liquid Crystal Display).

The interface 30 receives data necessary for processing in the image processing apparatus 1 and supplies the data to the decoder 10. The interface 30 receives the bit stream BS and the parameter PAR. The interface 30 is connected to an encoder that codes the image data using a coding method defined in, for example, MPEG-2 (Moving Picture Experts Group phase-2) and an input device such as a keyboard through a network such as a LAN (Local Area Network). The interface 30 can be locally connected to the encoder and the input device.

The decoder 10 will be explained below. FIG. 2 is a block diagram illustrating a configuration of the decoder 10. The decoder 10 includes a VLD (Variable Length Decoder) 11, an IDCT part 12, a motion vector part 13, an adder 14, and a frame memory 15.

The VLD 11 performs variable length decoding to generate a decoded variable length data DVLC and a motion vector MV. The VLD 11 generates the decoded variable length data DVLC and the motion vector MV by performing the variable length decoding on the bit stream BS from the interface 30. The VLD 11 supplies the decoded variable length data DVLC to the IDCT part 12 while supplying the motion vector MV to the motion vector part 13. FIG. 3 is a schematic diagram illustrating a data structure of the decoded variable length data DVLC. The decoded variable length data DVLC includes a maximum of 64 coefficients COEF0 to COEF63 that are arrayed in serial. The number of coefficients of the decoded variable length data DVLC is not limited to 64.

The IDCT part 12 performs the IDCT to generate a decoded pixel value (decoded image data) DPV. The IDCT part 12 performs the IDCT on the decoded variable length data DVLC using the parameter PAR, thereby generating the decoded pixel value DPV.

The motion vector part 13 generates a predicted pixel value (predicted image data) PPV. The motion vector part 13 generates the predicted pixel value PPV based on the decoded pixel (decoded image) DP (that is, the decoded pixel DP decoded in past times) and the motion vector MV that are stored in the frame memory 15.

The adder 14 generates the decoded pixel DP. The adder 14 adds the decoded pixel value DPV and the predicted pixel value PPV to generate the decoded pixel DP.

The decoded pixel DP is stored in the frame memory 15 in units of frames. The decoded pixel DP stored in the frame memory 15 is referred to by the motion vector part 13 in order to generate the predicted pixel value PPV.

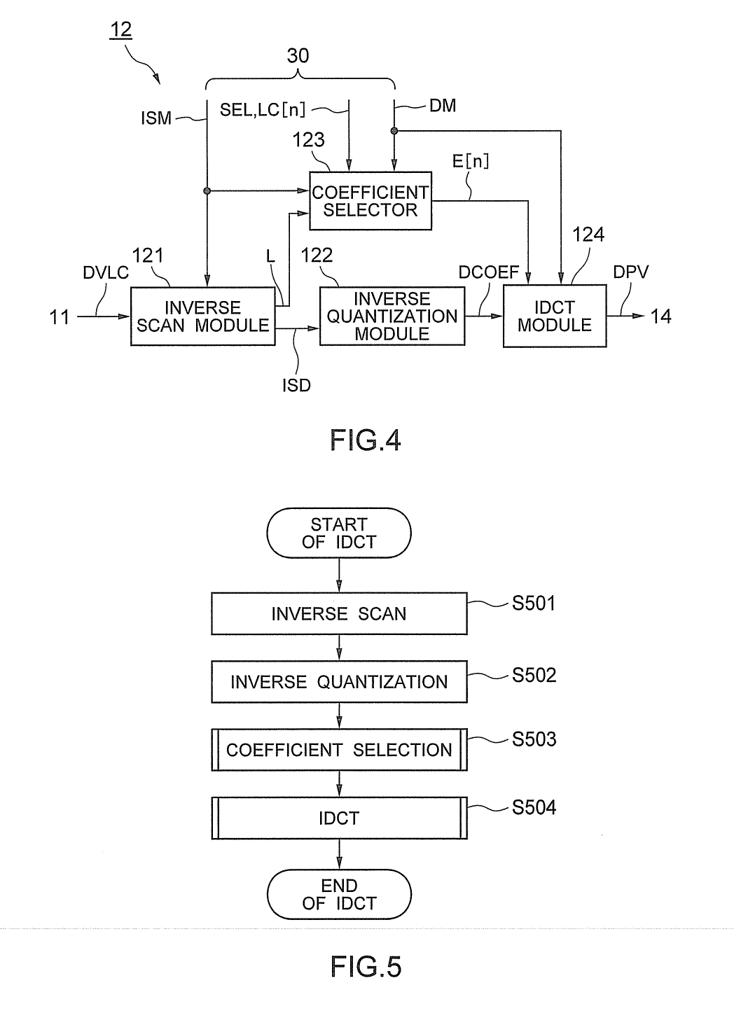

The IDCT part 12 will be explained below. FIG. 4 is a block diagram illustrating a configuration of the IDCT part 12. The IDCT part 12 includes an inverse scan module 121, an inverse quantization module 122, a coefficient selector 123, and an IDCT module 124.

FIG. 5 is a flowchart illustrating a procedure of the IDCT.

<Inverse Scan (S501)>

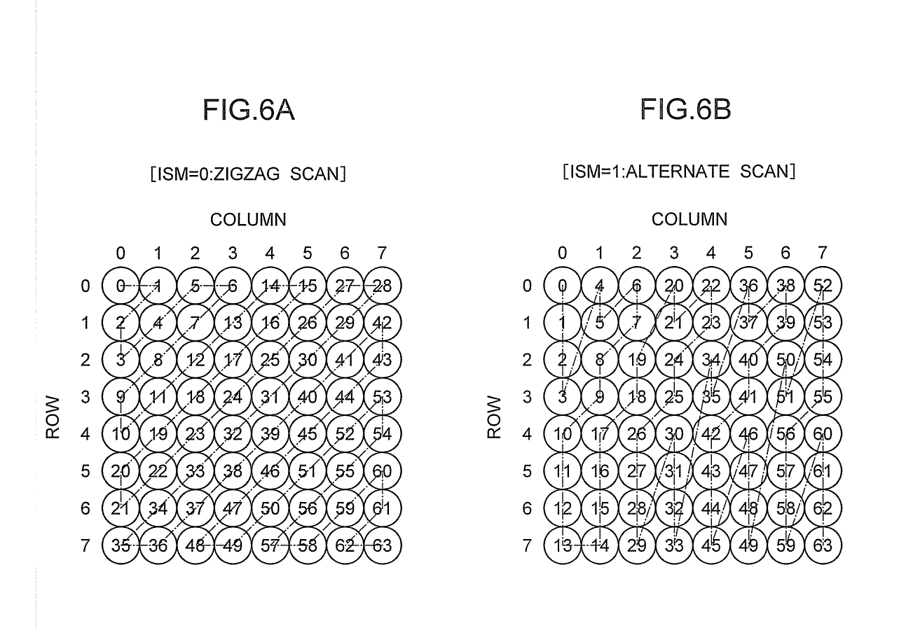

The inverse scan module 121 performs inverse scan (S501) to array the plural coefficients COEF constituting the decoded variable length data DVLC in the predetermined scan order (for example, to array the coefficients COEF into a two-dimensional matrix). The inverse scan module 121 selects an inverse scan mode corresponding to an inverse scan mode signal ISM from the interface 30. FIGS. 6A and 6B are schematic diagrams illustrating the inverse scan modes of an 8-by-8 two-dimensional matrix. For example, the inverse scan module 121 selects a zigzag scan mode of FIG. 6A for “ISM=0” and selects an alternate scan mode of FIG. 6B for “ISM=1”. The inverse scan mode signal ISM indicates the inverse scan mode for defining the scan order, and the inverse scan mode signal ISM is included in the parameter PAR supplied from the interface 30. The inverse scan module 121 generates inverse scan data ISD by arraying the coefficients COEF constituting the decoded variable length data DVLC in the scan order defined by the selected inverse scan mode, and the inverse scan module 121 extracts a last scan signal L. The last scan signal L is an identification number (identification information) of a rearmost coefficient (hereinafter referred to as “last scan coefficient LSC”) of the decoded variable length data DVLC. The inverse scan module 121 supplies the inverse scan data ISD to the inverse quantization module 122 while supplying the last scan signal L to the coefficient selector 123.

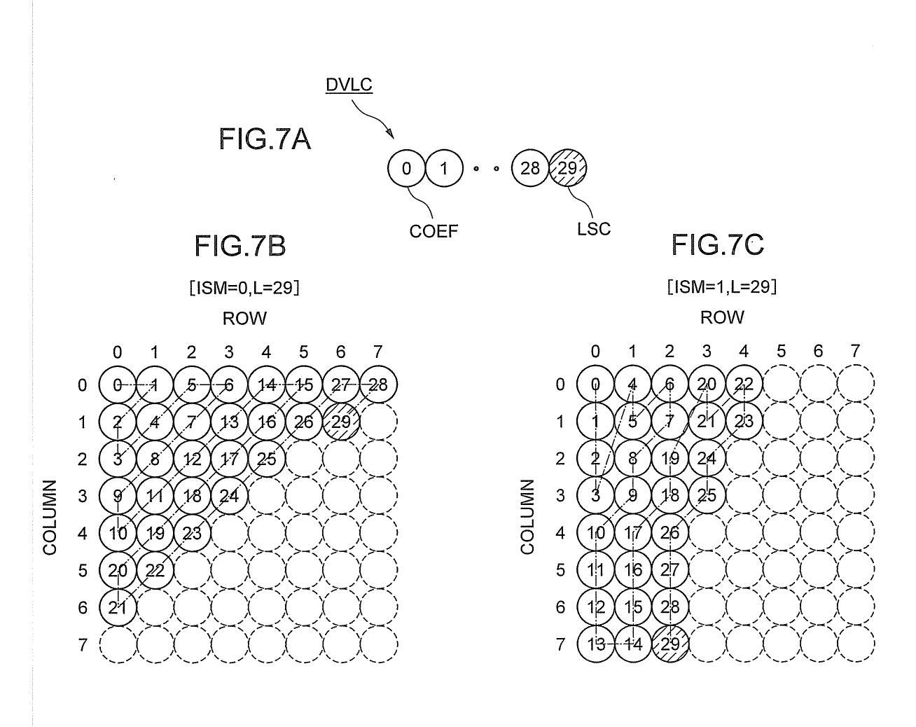

The inverse scan performed on the decoded variable length data DVLC will be explained below. FIGS. 7A to 7C are schematic diagrams illustrating an example of the inverse scan (S501). For example, FIG. 7A illustrates that the decoded variable length data DVLC includes the coefficients COEF0 to COEF29 and the coefficient COEF29 is the last scan coefficient LSC. At this point, the 30 coefficients COEF0 to CODF29 are arrayed as illustrated in FIG. 7B for “ISM=0” and arrayed as illustrated in FIG. 7C for “ISM=1”. The inverse scan module 121 can array the coefficients COEF to detect that the last scan signal L is 29 and the number of coefficients constituting the decoded variable length data DVLC is 30.

<Inverse Quantization (S502)>

The inverse quantization module 122 performs inverse quantization (S502) to generate a DCT coefficient DCOEF. The inverse quantization module 122 performs the inverse quantization on the inverse scan data ISD to generate the DCT coefficient DCOEF expressed by a two-dimensional matrix. The inverse scan module 121 and the inverse quantization module 122 may be implemented by one module.

<Coefficient Selection (S503)>

The coefficient selector 123 performs coefficient selection (S503) in each column or row of the DCT coefficient DCOEF to select a coefficient that becomes a target of an extended IDCT in the IDCT. The coefficient selector 123 generates an extending signal E[n] based on the last scan signal L, the inverse scan mode signal ISM, a decoding mode signal DM, a selection signal SEL, and a last scan check signal LC[n].

The selection signal SEL is arbitrarily determined by a user, which is used to switch the coefficient selector 123 between an operating state in which the coefficient selector 123 is operated and a non-operating state in which the coefficient selector 123 is not operated. The selection signal SEL is included in the parameter PAR supplied from the interface 30. The coefficient selector 123 becomes the non-operating state for “SEL=0” and the operating state for “SEL=1”.

The last scan check signal LC[n] is arbitrarily determined by the user, which is included in the parameter PAR supplied from the interface 30. Note that “n” expresses a column number or a row number of 0 to 7. That is, the last scan check signal LC[n] is set individually in each column or row of the DC coefficient DCOEF. The last scan check signal LC[n] is an identification number of the coefficient in each column arrayed in 0 to 7 or the coefficient in each row arrayed in 0 to 7. For example, when the mode of FIG. 6A is selected, “LC[0]=28” indicates that the last scan check signal of the column 0 is 28, “LC[1]=42” indicates that the last scan check signal of the column 1 is 42, “LC[2]=43” indicates that the last scan check signal of the column 2 is 43, and “LC[3]=53” indicates that the last scan check signal of the column 3 is 53. Any number can be set to the number of last scan check signals LC[n].

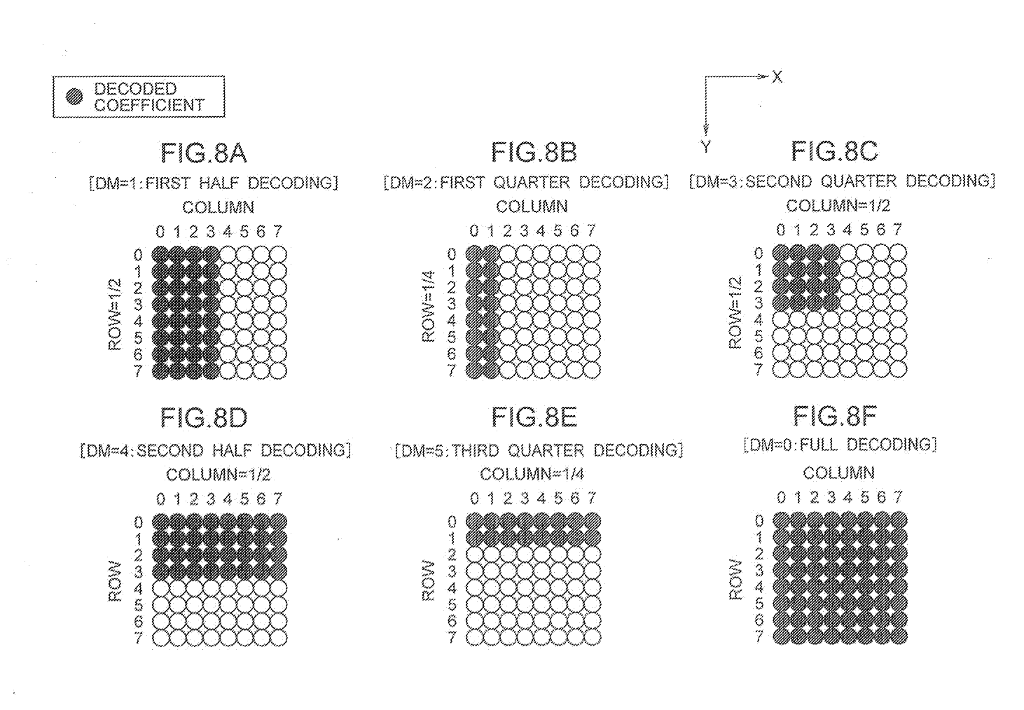

The decoding mode signal DM is arbitrarily determined by the user, which indicates a decoding mode in decoding and is included in the parameter PAR supplied from the interface 30. FIGS. 8A to 8F are schematic diagrams illustrating the decoding modes. For example, “DM=1” corresponds to a first half decoding mode (FIG. 8A) in which a processing amount in a row direction (X-direction of FIG. 8) is set to ½. “DM=2” corresponds to a first quarter decoding mode (FIG. 8B) in which the processing amount in the row direction is set to ¼. “DM=3” corresponds to a second quarter decoding mode (FIG. 8C) in which the processing amounts in the row direction and a column direction (Y-direction of FIG. 8) are set to ½. “DM=4” corresponds to a second half decoding mode (FIG. 8D) in which the processing amount in the column direction is set to ½. “DM=5” corresponds to a third quarter decoding mode (FIG. 8E) in which the processing amount in the column direction is set to ¼. “DM=0” corresponds to a full decoding mode (FIG. 8F). For example, the full decoding mode corresponds to a encoding method defined in MPEG-2.

The decoding mode signal DM may be determined by an operating frequency of a processor that executes an application of the display 20. For example, the first half decoding mode or second half decoding mode, which has the large processing amount, is selected when the processor of the display 20 has the operating frequency of a predetermined value or more, and one of the first to third quarter decoding modes, which have the small processing amount, is selected when the processor has the operating frequency lower than the predetermined value.

The decoding mode signal DM may dynamically be determined by the operating frequency of the processor of the display 20. For example, the first half decoding mode or second half decoding mode is selected when the processor of the display 20 can be operated at the operating frequency of a predetermined value or more, and one of the first to third quarter decoding modes is selected when the processor can be operated at the operating frequency lower than the predetermined value.

The extending signal E[n] indicates the target of the extended IDCT and is set in each column or row of the DCT coefficient DCOEF. For example, “E[n]=1” indicates that the column n of the DCT coefficient DCOEF is the target of the extended IDCT, and “E[n]=0” indicates that the column n of the DCT coefficient DCOEF is the target of the normal IDCT.

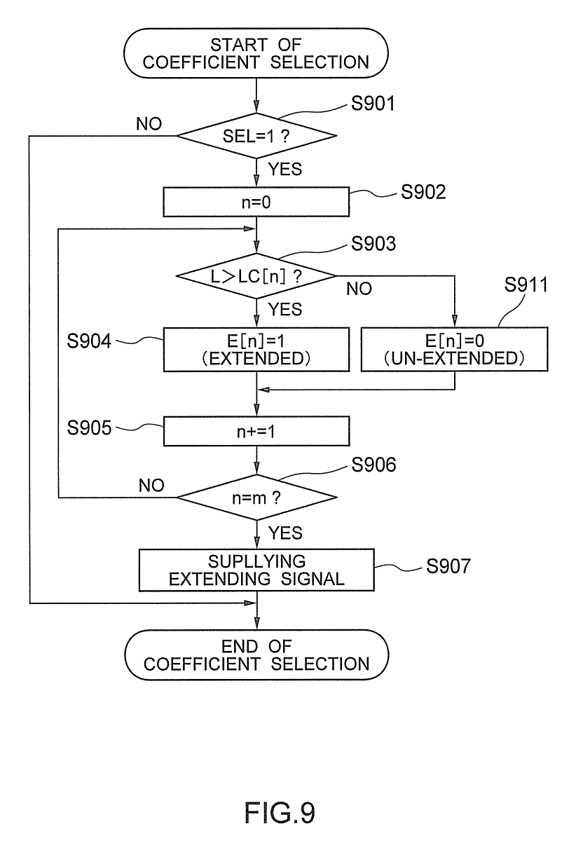

Coefficient selection (S503) of FIG. 5 will be explained in detail. FIG. 9 is a flowchart illustrating a procedure of the coefficient selection (S503). In the following specific example, it is assumed that “ISM” is set to 0, “DM” is set to 1, and the number “m” of LC[n]s is set to 4.

<S901 and S902>

The coefficient selector 123 determines whether the coefficient selection is performed based on the selection signal SEL (S901). For “SEL=0” (NO in S901) the coefficient selector 123 does not perform the coefficient selection. For “SEL=1” (YES in S901), an initial value “0” is set to the variable “n” (S902).

<S903, S904, and S911>

The coefficient selector 123 compares the last scan signal L and the last scan check signal LC[n] (S903). For “L>LC[n]” (YES in S903), the coefficient selector 123 sets a value “1” indicating the target of the extended IDCT on the extending signal E[n] (S904). For “L<LC[n]” (NO in S903), the coefficient selector 123 sets a value “0” indicating the target of the normal IDCT on the extending signal E[n] (S911). For example, the zigzag scan mode is selected for “ISM=0”, and “L=29” is larger than “LC[0]=28” for “n=1”, whereby the value “1” is set to “E[0]”. For “n=1 to 3”, the value “0” is set to “E[1] to E[3]”, because “L=29” is smaller than “LC[1]=42”, “LC[2]=43”, and “LC[3]=53”.

<S905 and S906>

The coefficient selector 123 adds 1 to “n” (S905). As a result, when “n” becomes equal to the number “m” of last scan check signals LC[n] (YES in S906), the flows goes to S907. As a result of S905, when “n” does not reach “m” (NO in S906), the flow returns to S903, and pieces of S903, S904 or S911, and S905 are repeated until “n” becomes equal to “m”. Therefore, the number of extending signals E[n] is set as many as the last scan check signals LC[n].

<S907>

The coefficient selector 123 supplies the extending signal E[n: 0 to m−1] to the IDCT module 124. For example, when the four last scan check signals LC[0] to LC[3] are supplied from the interface 30, the coefficient selector 123 supplies the four extending signals E[0] to E[3] to the IDCT module 124. When the processing in S907 is ended, the coefficient selection is ended.

<IDCT (S504)>

The IDCT module 124 performs the IDCT (S504) to generate the decoded pixel value DPV. The IDCT module 124 generates the decoded pixel value DPV by performing the extended IDCT or the normal IDCT on the DCT coefficient DCOEF based on the extending signal E[n].

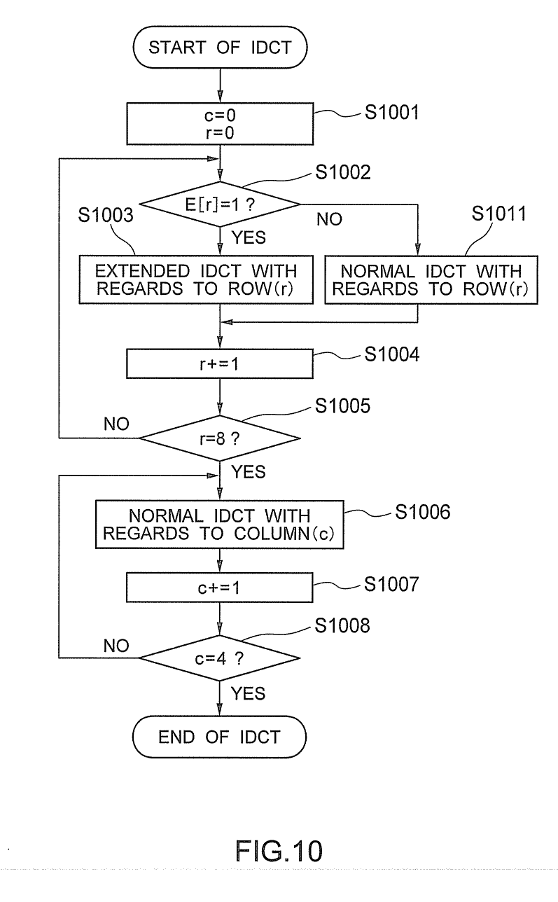

The IDCT (S504) for “DM=1” will be explained below. FIG. 10 is a flowchart illustrating a procedure of the IDCT (S504) for “DM=1”.

<S1001>

The IDCT module 124 sets an initial value (for example, 0) to “c” and “r” (S1001). Where “c” is a variable indicating a column that becomes the target of the IDCT, and “r” is a variable indicating a row that becomes the target of the IDCT.

<S1002, S1003, and S1011>

The IDCT module 124 determines whether “E[r]” is 1 (that is, whether the row “r” that becomes the target of the IDCT is the extended IDCT) (S1002). For “E[r]=1” (YES in S1002), the IDCT module 124 performs the extended IDCT (S1003) with regards to the row “r”. In the extended IDCT (S1003) with regards to the row “r”, the IDCT is performed on the coefficients of the columns 4 to 7 of the row “r” in the row direction in addition to the coefficients of the columns 0 to 3 of the row “r”. For “E[r]=0” (NO in S1062), the IDCT module 124 performs the normal IDCT (S1011) with regards to the row “r”. In the extended IDCT (S1011) with regards to the row “r”, the IDCT is performed on the coefficients of the columns 0 to 3 of the row “r” in the row direction. In S1011, the IDCT is not performed on the coefficients of the columns 4 to 7 of the row “r”.

<S1004 to S1006>

The IDCT module 124 adds 1 to the variable “r” (S1004). As a result of S1004, when the variable “r” reaches 8 (that is, when the extended IDCT (S1003) or the normal IDCT (S1011) is completed to all the rows 0 to 7) (YES in S1005), the IDCT module 124 performs the normal IDCT (S1006) with regards to the column “c”. In the normal IDCT (S1006) with regards to the column “c”, the IDCT is performed on the coefficients of the rows 0 to 7 of the column “c” in the column direction. As a result of S1004, when the variable “r” does not reach 8 (that is, when the extended IDCT (S1003) or the normal IDCT (S1011) is not completed to all the rows 0 to 7) (NO in S1005), the flow returns to S1002, and the IDCT module 124 performs the extended IDCT (S1003) or the normal IDCT (S1011) with regards to the row “r” of the target.

<S1007 and S1008>

The IDCT module 124 adds 1 to the variable “c” (S1007). As a result of S1007, when the variable “c” reaches 4 (that is, when the normal IDCT (S1006) is completed to all the columns 0 to 3) (YES in S1008), the IDCT is ended. As a result of S1007, when the variable “c” does not reach 4 (that is, when the normal IDCT (S1006) is not completed to all the columns 0 to 3) (NO in S1008), the flow returns to S1006, and the IDCT module 124 performs the IDCT with regards to the column “c” of the target.

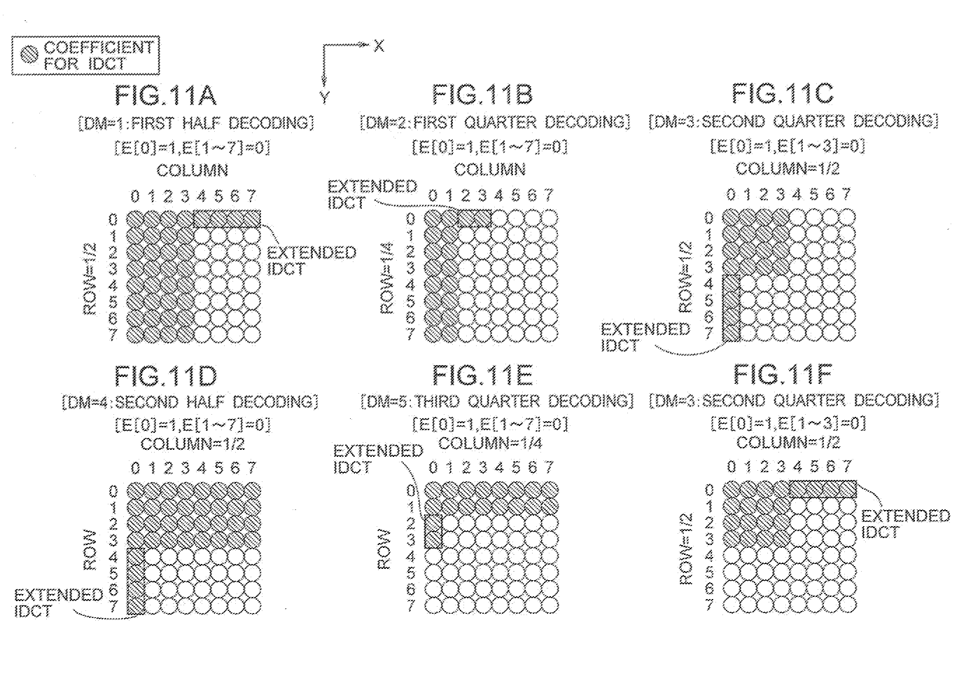

The DCT coefficient DCOEF of FIG. 11A is obtained through the procedure of FIG. 10. In the DCT coefficient DCOEF of FIG. 11A, compared with FIG. 8A, the IDCT is extensionally performed on the coefficients of the columns 4 to 7 of the row 0. As a result, the decoded image data in which the image quality is not degraded can be generated even if the first half decoding mode is selected.

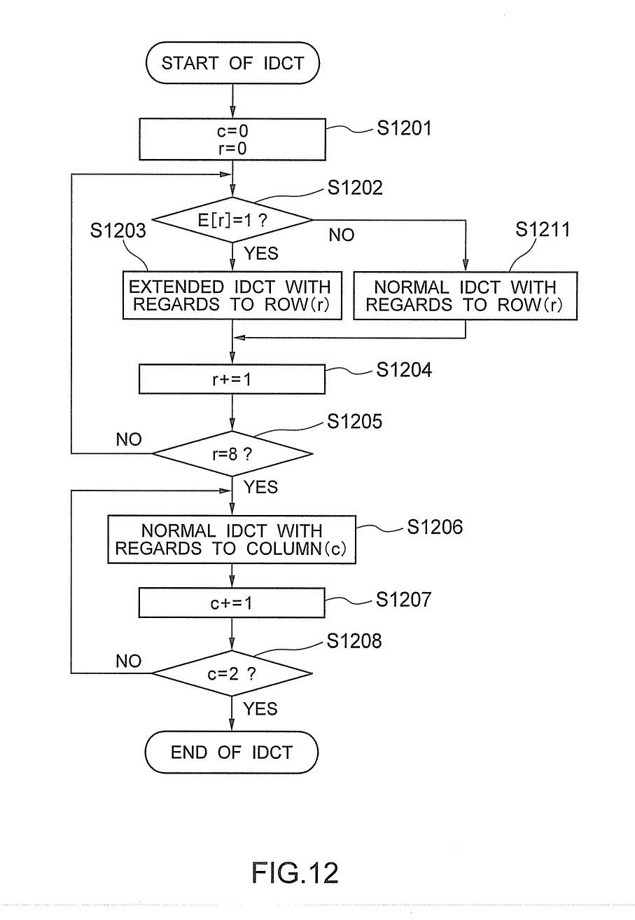

The IDCT (S504) for “DM=2” will be explained below. FIG. 12 is a flowchart illustrating a procedure of the IDCT (S504) for “DM=2”.

<S1201>

The IDCT module 124 sets an initial value (for example, j) to the variables “c” and “r” (S1201).

<S1202, S1203, and S1211>

The IDCT module 124 determines whether “E[r]” is 1 (that is, whether the row “r” that becomes the target of the IDCT is the target of the extended IDCT) (S1202). For “E[r]=1” (YES in S1202), the IDCT module 124 performs the extended IDCT (S1203) with regards to the row “r”. In the extended IDCT (S1203) with regards to the row “r”, the IDCT module 124 performs the IDCT on the coefficients of the columns 2 and 3 of the row “r” in the row direction in addition to the columns 0 and 1 of the row “r”. For “E[r]=0” (NO in S1202), the IDCT module 124 performs the normal IDCT (S1211) with regards to the row “r”. In the normal IDCT (S1211) with regards to the row “r”, the IDCT module 124 performs the IDCT on the coefficients of the columns 0 and 1 of the row “r” in the row direction. In S1211, the IDCT module 124 does not perform the IDCT on the coefficients of the columns 2 to 7 of the row “r”.

<S1204 to S1206>

The IDCT module 124 adds 1 to the variable “r” (S1204). As a result of S1204, when the variable “r” reaches 8 (that is, when the extended IDCT (S1203) or the normal IDCT (S1211) is completed to all the rows 0 to 7) (YES in S1205), the IDCT module 124 performs the normal IDCT (S1206) with regards to the column “c”. In the normal IDCT (S1206) with regards to the column “c”, the IDCT module 124 performs the IDCT on the coefficients of the rows 0 to 7 of the column “c” in the column direction. As a result of S1204, when the variable “r” does not reach 8 (that is, when the extended IDCT (S1203) or the normal IDCT (S1211) is not completed to all the rows 0 to 7) (NO in S1205), the flow returns to S1202, and the IDCT module 124 performs the extended IDCT (S1203) or the normal IDCT (S1211) with regards to the row “r” of the target.

<S1207 and S1208>

The IDCT module 124 adds 1 to the variable “c” (S1207). As a result of S1207, when the variable “c” reaches 2 (that is, when the normal IDCT (S1206) is completed to all the columns 0 and 1 that become the target of the IDCT) (YES in S1208), the IDCT is ended. As a result of S1207, when the variable “c” does not reach 2 (that is, when the normal IDCT (S1206) is not completed to all the columns 0 and 1 that become the target of the IDCT) (NO in S1208), the flow returns to S1206, and the IDCT module 124 performs the IDCT with regards to the column “c” of the target.

The DCT coefficient DCOEF of FIG. 11B is obtained through the procedure of FIG. 12. In the DCT coefficient DCOEF of FIG. 118, compared with FIG. 8B, the IDCT is extensionally performed on the coefficients of the columns 2 and 3 of the row 0. As a result, the decoded image data in which the image quality is not degraded can be generated even if the first quarter decoding mode is selected.

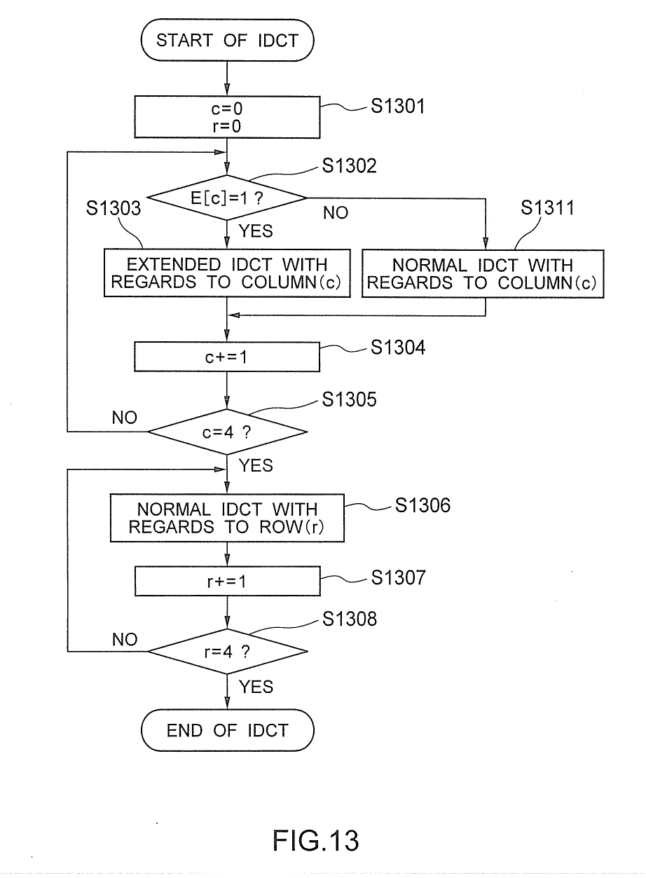

The IDCT (S504) for “DM=3” will be explained below. FIG. 13 is a flowchart illustrating a procedure of the IDCT (S504) for “DM=3”.

<S1301>

The IDCT module 124 sets an initial value (for example, 0) to the variables “c” and “r” (S1301).

<S1302, S1303, and S1311>

The IDCT module 124 determines whether “E[c]” is 1 (that is, whether the column “c” that becomes the target of the IDCT is the target of the extended IDCT) (S1302). For “E[c]=1” (YES in S1302), the IDCT module 124 performs the extended IDCT (S1303) with regards to the column “c”. In the extended IDCT (S1303) with regards to the column “c”, the IDCT module 124 performs the IDCT on the coefficients of the rows 4 to 7 of the column “c” in the column direction in addition to the rows 0 and 3 of the column “c”. For “E[c]=0” (NO in S1302), the IDCT module 124 performs the normal IDCT (S1311) with regards to the column “c”. In the normal IDCT (S1311) with regards to the column “c”, the IDCT module 124 performs the IDCT on the coefficients of the rows 0 and 3 of the column “c” in the column direction. In S1311, the IDCT module 124 does not perform the IDCT on the coefficients of the rows 4 to 7 of the column “c”.

<S1304 to S1306>

The IDCT module 124 adds 1 to the variable “c” (S1304). As a result of S1304, when the variable “c” reaches 4 (that is, when the extended IDCT (S1303) or the normal IDCT (S1311) is completed to all the columns 0 to 3) (YES in S1305), the IDCT module 124 performs the normal IDCT (S1306) with regards to the row “r”. In the normal IDCT (S1306) to the row “r”, the IDCT module 124 performs the IDCT on the coefficients of the columns 0 to 3 of the row “r” in the row direction. As a result of S1304, when the extended IDCT (S1303) or the normal IDCT (S1311) is not completed to all the columns 0 to 3) (NO in S1305), the flow returns to S1302, and the IDCT module 124 performs the extended IDCT (S1303) or the normal IDCT (S1311) with regards to the column “c” of the target.

<S1307 and S1308>

The IDCT module 124 adds 1 to the variable “r” (S1307). As a result of S1307, when the variable “r” reaches 4 (that is, when the normal IDCT (S1306) is completed to all the rows 0 to 3 that become the target of the IDCT) (YES in S1308), the IDCT is ended. As a result of S1307, when the variable “r” does not reach 4 (that is, when the normal IDCT (S1306) is not completed to all the rows 0 to 3 that become the target of the IDCT) (NO in S1308), the flow returns to S1306, and the IDCT module 124 performs the IDCT with regards to the row “r” of the target.

The DCT coefficient DCOEF of FIG. 11C is obtained through the procedure of FIG. 13. In the DCT coefficient DCOEF of FIG. 11C, compared with FIG. 8C, the IDCT is extensionally performed on the coefficients of the rows 4 to 7 of the column 0. As a result, the decoded image data in which the image quality is not degraded can be generated even if the second quarter decoding mode is selected.

The IDCT (S504) for “DM=4” is implemented by replacing the pieces of processing relating to the column and the pieces of processing relating to the row with each other in FIG. 10. Therefore, the DCT coefficient DCOEF of FIG. 11D is obtained. In the DCT coefficient DCOEF of FIG. 11D, compared with FIG. 8D, the IDCT is extensionally performed on the coefficients of the rows 4 to 7 of the column 0. As a result, the decoded image data in which the image quality is not degraded can be generated even if the second half decoding mode is selected.

The IDCT (S504) for “DM=5” is implemented by replacing the pieces of processing relating to the column and the pieces of processing relating to the row with each other in FIG. 12. Therefore, the DCT coefficient DCOEF of FIG. 11E is obtained. In the DCT coefficient DCOEF of FIG. 11E, compared with FIG. 8E, the IDCT is extensionally performed on the coefficients of the rows 2 and 3 of the column 0. As a result, the decoded image data in which the image quality is not degraded can be generated even if the third quarter decoding mode is selected.

For “DM=3”, the IDCT (S504) may be implemented by replacing the pieces of processing relating to the column and the pieces of processing relating to the row with each other in FIG. 13. Therefore, the DCT coefficient DCOEF of FIG. 11F is obtained. In the DCT coefficient DCOEF of FIG. 11F, compared with FIG. 8F, the IDCT is extensionally performed on the coefficients of the columns 4 to 7 of the row 0. As a result, the decoded image data in which the image quality is not degraded can be generated even if the second quarter decoding mode is selected.

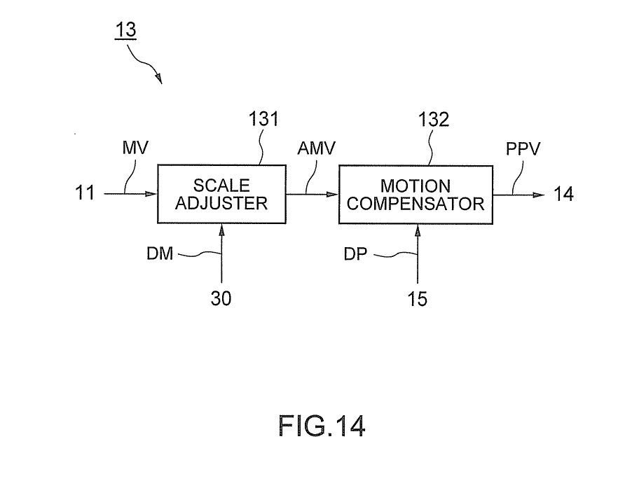

The motion vector part 13 will be explained below. FIG. 14 is a block diagram illustrating a configuration of the motion vector part 13. The motion vector part 13 includes a scale adjuster 131 and a motion compensator 132.

The scale adjuster 131 adjusts a scale of the motion vector MV. The scale adjuster 131 adjusts the scale of the motion vector MV based on the decoding mode (FIG. 8A to FIG. 8E) corresponding to the decoding mode signal DM, thereby generating a motion vector (hereinafter referred to as “adjusted motion vector AMV”) whose scale is adjusted. Therefore, a size of the decoded pixel DP, which is referred to by the motion compensator 132 and stored in the frame memory 15, and the predicted pixel value PPV generated by the motion compensator 132 can be reduced.

The motion compensator 132 generates the predicted pixel value PPV. The motion compensator 132 generates the predicted pixel value PPV from the adjusted motion vector AMV by referring to the decoded pixel DP stored in the frame memory 15. Then the motion compensator 132 supplies the predicted pixel value PPV to the adder 14.

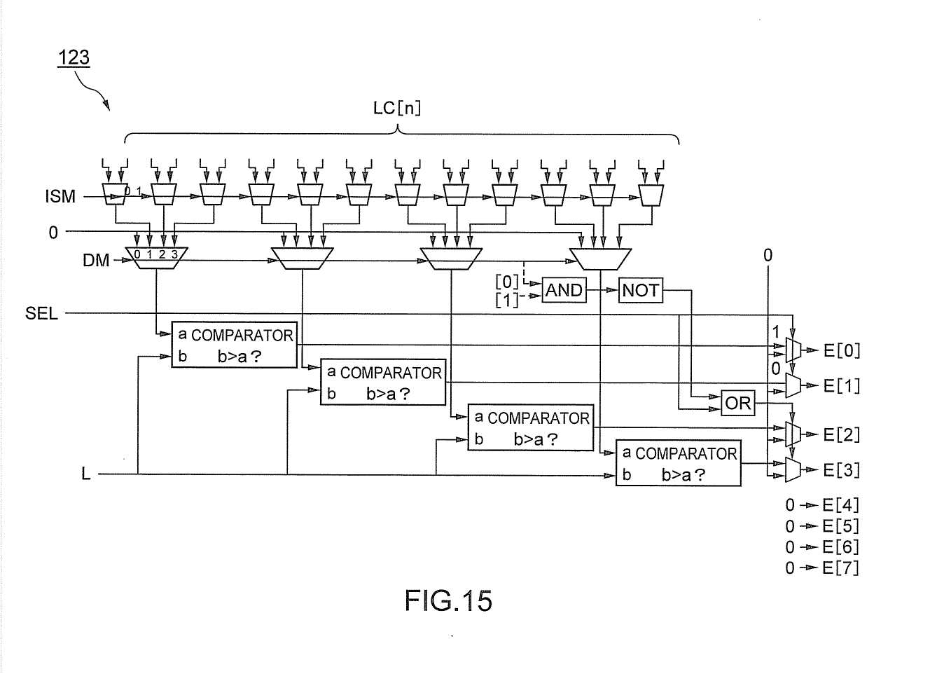

In the embodiment, the coefficient selector 123 may be implemented by software or a logic circuit illustrated in FIG. 15. In FIG. 15, the plural last scan check signals LC[n] are supplied in each combination of the inverse scan mode and the decoding mode.

According to the embodiment, in the IDCT, the coefficient selection (S503) is performed to select the coefficient that becomes the target of the extended IDCT in each column or row of the DCT coefficient DCOEF. Therefore, the decoded image data in which the image quality is not degraded can be generated to display the high-quality image on the display 20 even if the decoding mode is selected to reduce the processing amount of the decoder 10.

Further, according to the embodiment, the coefficient selector 123 is switched between the operating state and the non-operating state based on the selection signal SEL, the power consumption can be reduced in the IDCT module 12 and the decoder 10.

At least a portion of an image processing apparatus 1 according to the above-described embodiments may be composed of hardware or software. When at least a portion of the image processing apparatus 1 is composed of software, a program for executing at least some functions of the image processing apparatus 1 may be stored in a recording medium, such as a flexible disk or a CD-ROM, and a computer may read and execute the program. The recording medium is not limited to a removable recording medium, such as a magnetic disk or an optical disk, but it may be a fixed recording medium, such as a hard disk or a memory.

In addition, the program for executing at least some functions of the image processing apparatus 1 according to the above-described embodiment may be distributed through a communication line (which includes wireless communication) such as the Internet. In addition, the program may be encoded, modulated, or compressed and then distributed by wired communication or wireless communication such as the Internet. Alternatively, the program may be stored in a recording medium, and the recording medium having the program stored therein may be distributed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An inverse discrete cosine transforming apparatus comprising:
an inverse scan module configured to array a plurality of coefficients constituting decoded variable length data generated from bit stream of coded data in a predetermined scan order to generate inverse scan data;
an inverse quantization module configured to perform an inverse quantization on the inverse scan data to generate a discrete cosine transform coefficient;
a coefficient selector configured to generate an extending signal for each scan data; and
an inverse discrete cosine transform module configured to perform an inverse discrete cosine transform on the discrete cosine transform coefficient based on the extending signal to generate decoded image data.

2. The apparatus of claim 1, wherein the inverse scan module extracts a last scan signal being an identification number of a rearmost last scan coefficient of the decoded variable length data, and
the coefficient selector generates the extending signal in accordance with a difference between a predetermined last scan check signal and the last scan signal, the last scan check signal set individually in each column or row.

3. The apparatus of claim 2, wherein the coefficient selector generates the extending signal for the column or row for which the last scan signal larger than the last scan check signal is set.

4. The apparatus of claim 1, wherein an operating state and a non-operating state of the coefficient selector are switched based a predetermined selection signal.

5. The apparatus of claim 1, wherein when a half decoding mode to reduce a size of the column or row of the discrete cosine transform coefficients to half is set, the inverse discrete cosine transform module performs the inverse discrete cosine transform on all the coefficients of the column or row corresponding to the extending signal.

6. The apparatus of claim 1, wherein when a first quarter decoding mode to reduce a size of the column or row of the discrete cosine transform coefficients to quarter is set, the inverse discrete cosine transform module performs the inverse discrete cosine transform on a half of all the coefficients of the column or row corresponding to the extending signal.

7. The apparatus of claim 1, wherein when a second quarter decoding mode to reduce a size of the column and row of the discrete cosine transform coefficients to half is set, the inverse discrete cosine transform module performs the inverse discrete cosine transform on a half of all the coefficients of the column and row corresponding to the extending signal.

8. A decoder comprising:
a variable length decoder configured to perform variable length decoding on bit stream of coded data to generate decoded variable length data and a motion vector;
an inverse scan module configured to array a plurality of coefficients constituting the decoded variable length data in a predetermined scan order to generate inverse scan data;
an inverse quantization module configured to perform an inverse quantization on the inverse scan data to generate a discrete cosine transform coefficient;
a coefficient selector configured to generate an extending signal for each scan data; and
an inverse discrete cosine transform module configured to perform an inverse discrete cosine transform on the discrete cosine transform coefficient based on the extending signal to generate decoded image data;
a motion vector part configured to generate a predicted image data based on decoded image of a previous frame and the motion vector; and
an adder configured to add the decoded image data and the motion vector to generate the decoded image.

9. The decoder of claim 8, wherein the inverse scan module extracts a last scan signal being an identification number of a rearmost last scan coefficient of the decoded variable length data, and
the coefficient selector generates the extending signal in accordance with a difference between a predetermined last scan check signal and the last scan signal, the last scan check signal set individually in each column or row.

10. The decoder of claim 9, wherein the coefficient selector generates the extending signal for the column or row for which the last scan signal larger than the last scan check signal is set.

11. The decoder of claim 8, wherein an operating state and a non-operating state of the coefficient selector are switched based a predetermined selection signal.

12. The decoder of claim 8, wherein when a half decoding mode to reduce a size of the column or row of the discrete cosine transform coefficients to half is set, the inverse discrete cosine transform module performs the inverse discrete cosine transform on all the coefficients of the column or row corresponding to the extending signal.

13. The decoder of claim 8, wherein when a first quarter decoding mode to reduce a size of the column or row of the discrete cosine transform coefficients to quarter is set, the inverse discrete cosine transform module performs the inverse discrete cosine transform on a half of all the coefficients of the column or row corresponding to the extending signal.

14. The decoder of claim 8, wherein when a second quarter decoding mode to reduce a size of the column and row of the discrete cosine transform coefficients to half is set, the inverse discrete cosine transform module performs the inverse discrete cosine transform on a half of all the coefficients of the column and row corresponding to the extending signal.

15. An image processing apparatus comprising:
a variable length decoder configured to perform variable length decoding on bit stream of coded data to generate decoded variable length data and a motion vector;
an inverse scan module configured to array a plurality of coefficients constituting the decoded variable length data in a predetermined scan order to generate inverse scan data;
an inverse quantization module configured to perform an inverse quantization on the inverse scan data to generate a discrete cosine transform coefficient;
a coefficient selector configured to generate an extending signal for each scan data; and
an inverse discrete cosine transform module configured to perform an inverse discrete cosine transform on the discrete cosine transform coefficient based on the extending signal to generate decoded image data;
a motion vector part configured to generate a predicted image data based on decoded image of a previous frame and the motion vector;
an adder configured to add the decoded image data and the motion vector to generate the decoded image; and
a display configured to display the decoded image.

16. The apparatus of claim 15, wherein the inverse scan module extracts a last scan signal being an identification number of a rearmost last scan coefficient of the decoded variable length data, and
the coefficient selector generates the extending signal in accordance with a difference between a predetermined last scan check signal and the last scan signal, the last scan check signal set individually in each column or row.

17. The apparatus of claim 16, wherein the coefficient selector generates the extending signal for the column or row for which the last scan signal larger than the last scan check signal is set.

18. The apparatus of claim 15, wherein an operating state and a non-operating state of the coefficient selector are switched based a predetermined selection signal.

19. The apparatus of claim 15, wherein when a half decoding mode to reduce a size of the column or row of the discrete cosine transform coefficients to half is set, the inverse discrete cosine transform module performs the inverse discrete cosine transform on all the coefficients of the column or row corresponding to the extending signal.

20. The apparatus of claim 15, wherein when a first quarter decoding mode to reduce a size of the column or row of the discrete cosine transform coefficients to quarter is set, the inverse discrete cosine transform module performs the inverse discrete cosine transform on a half of all the coefficients of the column or row corresponding to the extending signal.
